(19) United States
(12) Patent Application Publication
(10) Pub. No.: US 2002/0108471 A1
(43) Pub. Date: Aug. 15, 2002

(54) Ratchet wrench

(76) Inventor: Mu-Lin Chen, Taipei (TW)

Correspondence Address: CHEN, Mu-Lin, P.O. Box 82-144, Taipei, TW

(21) Appl. No.: 09/781,246

(22) Filed: Feb. 13, 2001

(51) Int. Cl. B25B 13/46

(52) U.S. Cl. 81/63.2

(57) ABSTRACT

An improved structure of a ratchet wrench characterized in that the ratchet wrench is provided with an adaptation hole to accommodate a ratchet wheel having a plurality of mounting teeth surrounding the external circumferential edge, one lateral side of the adaptation hole is provided with an adaptation recess to accommodate a stopping teeth, a directional block, two resisting element and two elastic bodies, and two resisting edges are provided at an appropriate position on the adaptation recess, and a notch is formed on the stopping teeth which is protruded out with a pivotal rod, the directional block is pivotally mounted to the pivotal rod, and one side of the stopping teeth is provided with a plurality of engaging teeth which is engageable with the engaging teeth of the ratchet wheel, the side face of the stopping teeth is restricted by a left and a right resisting element, and the top end of the two resisting element is formed into a bottom end which is restricted at the stopping face of the stopping teeth, the end terminal of the resisting element is formed into a resisting edge and is then urged at the resisting edge of the adaptation recess, and the two resisting elements are urged by the elastic body such that the elasticity of the elastic body can be engaged with the ratchet wheel, thereby the rotating of the directional block will push to press the resisting element to urge the resisting element and the stopping teeth to separate and the ratchet wrench rotates in one direction, and the pushing of another resisting element will separate the resisting element from the stopping teeth, and the ratchet wrench will rotate in another direction.

### BACKGROUND OF THE INVENTION

(a) Field of the Invention

The present invention relates to a ratchet wrench having high torque and bi-directional driving mechanism.

(b) Description of the Prior Art

U.S. Pat. No. 5,626,062, entitled “Socket and Ratchet Wrench” discloses a structure of a ratchet wrench, wherein an adaptation hole is provided on the ratchet wrench to accommodate a ratchet wheel. The external circumferential edge of the ratchet wheel is provided with mounting teeth. One side of the adaptation hole is provided with an adaptation recess to accommodate a stopping tooth, steel ball and a spring. The two lateral sides of the stopping teeth are provided with teeth to engage with the mounting teeth of the ratchet wheel. The stopping teeth can rotate at a definite angle such that the teeth at one side of the stopping teeth can engage with the mounting teeth of the ratchet wheel. Thus, the ratchet wrench has a function of rotate a fastening element in one direction. To rotate in another direction, the stopping tooth is rotated such that the teeth at the other side of the stopping teeth are in engagement with the mounting teeth of the ratchet wheel. Thus, the ratchet wrench is provided with another direction rotation.

However, this structure has the drawback that only a few teeth of the ratchet wheel are in engagement with the stopping teeth during the driving of the ratchet wrench. If the torque is too great, the mounting teeth of the ratchet wheel or the stopping teeth may be damaged.

Taiwan Publication No. 262785, entitled “Driving Structure of a Tool” discloses the structure of a ratchet wrench having an adaptation hole to accommodate a ratchet wheel, etc. This structure is substantially similar to that of the U.S. Pat. No. 5,626,062. However, this structure can withstand a large torque.

However, the drawback of this structure is that the design for the size of the adaptation recess, size of the stopping teeth and the gap between the individual teeth of the ratchet wheel have to be very precise. Otherwise, the engagement between the teeth of the ratchet wheel and the stopping teeth may not smooth. In other words, only a small tolerance for the teeth is allowed in order to provide a bi-directional rotation for the ratchet wrench.

Accordingly, it is an object of the present invention to provide an improved structure of a ratchet wrench to alleviate the above drawbacks.

### SUMMARY OF THE INVENTION

Accordingly, it is an object of the present invention to provide ratchet wrench, wherein the ratchet wheel is provided with a high torque and a bi-directional mechanism.

Yet another object of the present invention is to provide An improved structure of a ratchet wrench characterized in that the ratchet wrench is provided with an adaptation hole to accommodate a ratchet wheel having a plurality of mounting teeth surrounding the external circumferential edge, one lateral side of the adaptation hole is provided with an adaptation recess to accommodate a stopping teeth, a directional block, two resisting element and two elastic bodies, and two resisting edges are provided at an appropriate position on the adaptation recess, and a notch is formed on the stopping teeth which is protruded out with a pivotal rod, the directional block is pivotally mounted to the pivotal rod, and one side of the stopping teeth is provided with a plurality of engaging teeth which is engageable with the engaging teeth of the ratchet wheel, the side face of the stopping teeth is restricted by a left and a right resisting element, and the top end of the two resisting element is formed into a bottom end which is restricted at the stopping face of the stopping teeth, the end terminal of the resisting element is formed into a resisting edge and is then urged at the resisting edge of the adaptation recess, and the two resisting elements are urged by the elastic body such that the elasticity of the elastic body can be engaged with the ratchet wheel, thereby the rotating of the directional block will push to press the resisting element to urge the resisting element and the stopping teeth to separate and the ratchet wrench rotates in one direction, and the pushing of another resisting element will separate the resisting element from the stopping teeth, and the ratchet wrench will rotate in another direction.

Other objects, and advantages of the present invention can be more fully understood by reading the following detailed description of the preferred embodiment, with reference to the accompanying.

### BRIEF DESCRIPTION OF THE DRAWINGS

FIG. 1 is a perspective exploded view of the ratchet wrench of the present invention.

FIG. 2 is a perspective view of the ratchet wrench of the present invention.

FIG. 3 is a schematic view of the ratchet wrench of the present invention.

FIG. 4 is a schematic view of the ratchet wrench, indicating the clockwise rotation of the ratchet wrench.

FIG. 5 is a schematic view of the ratchet wrench, indicating the disengagement of teeth of the ratchet wrench rotating clockwise.

FIG. 6 is a schematic view of the ratchet wrench, indicating the counter clockwise rotation of the ratchet wrench.

FIG. 7 is a schematic view of the ratchet wrench, indicating the disengagement of teeth of the ratchet wrench rotating counter clockwise.

FIG. 8 is a schematic view of another preferred embodiment of the present invention.

### DETAILED DESCRIPTION OF THE PRESENT INVENTION

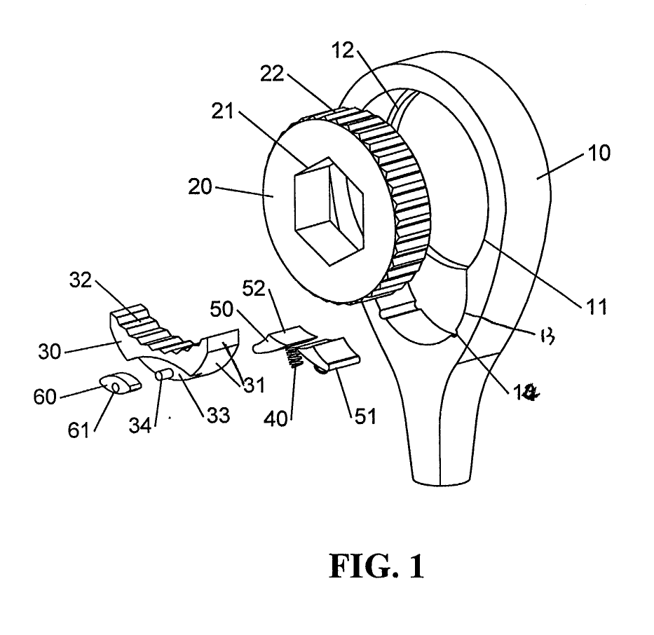

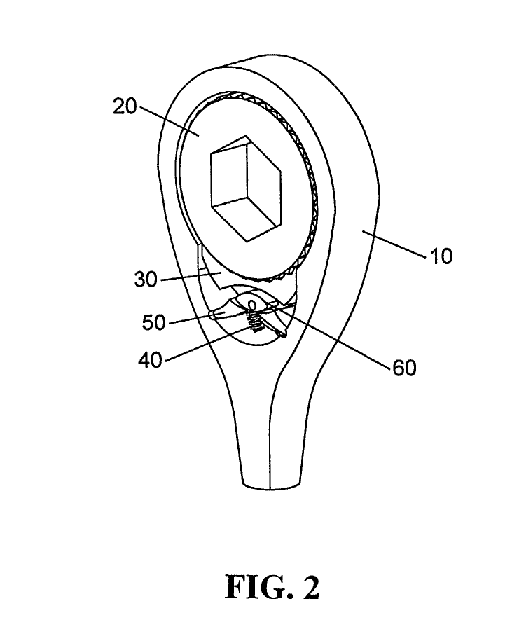

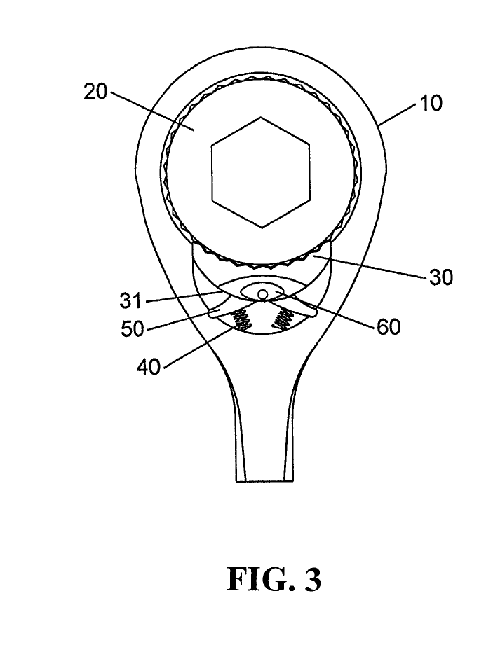

Referring to FIG. 1, there is shown an improved structure of a ratchet wheel 10 having an adaptation hole 11, and the internal diameter of the bottom end of the adaptation hole 11 is tapered to form into an engaging edge 12. The adaptation hole 11 can be placed with a ratchet wheel 20 and the external circumferential edge of the ratchet wheel 20 is provided with a plurality of mounting teeth 22. The center of the ratchet wheel 20 is a hexagonal recess 21 or other shapes of recesses to combine with other screwing components. One lateral side of the adaptation hole 11 is provided with an adaptation recess 13 for the positioning of a stopping tooth 30, a directional block 60, two resisting elements 50 and two elastic bodies 40. The adaptation recess 13 is positioned at an appropriate position to form two resisting edges 14. The stopping tooth 30 is substantially an arch-shaped element and is provided with a notch 33. At an appropriate position on the notch 33, a pivotal rod 34 is protruded, and the directional block 60 is positioned on the pivotal rod 34. The center of the directional block 60 is pivoting hole 61 for mounting the directional block 60 onto the pivotal rod 34. One lateral side of the stopping teeth 30 is provided with a plurality of engaging teeth 32 for the combination with the mounting teeth 22. Two lateral sides of the stopping teeth are formed respectively into an urging face 31 which urge against the two lateral sides of the adaptation recess 13. Another side of the stopping teeth 30 is restricted by the two resisting elements 50. The top end of the two resisting elements 50 resists against the resisting face 52 at the bottom end of the stopping teeth 30. The end terminal of the resisting elements 50 is formed into a blocking edge 51 which urges at the resisting edge 14. The two resisting elements 50 are urged by the elastic body 40 such that the stopping teeth 30 is in engagement with the ratchet wheel as a result of the elasticity of the elastic body 40. The other end of the elastic body 40 urges at the side of the adaptation recess 13. FIG. 2 is a perspective view of the wrench and FIG. 3 is a front view of the wrench in accordance with the present invention.

A panel is mounted to the wrench so as to cover all the components of the wrench. In accordance with the present invention, a hole is provided at a position corresponding to the position of the directional block 60, and a rotating button is mounted to the directional block 60. Thus, the ratchet wrench 10 can be controlled by the external rotating of the rotating button of the ratchet wrench 10 to change the direction of the directional block 60.

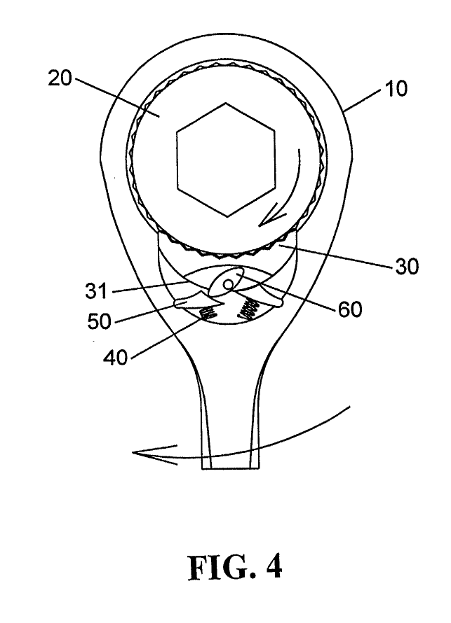

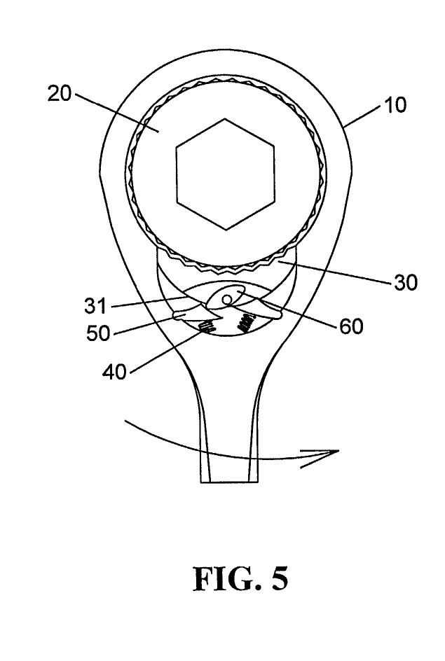

Referring to FIG. 4, the rotating of the directional block 60 causes the directional block 60 to urge against the left resisting element 50 so that the left resisting element 50 is disengaged from the stopping teeth 30. When the ratchet wrench 10 rotates clockwise, the ratchet wrench 10 presses against the right resisting element 50 and the right resisting element 50 urges the stopping teeth 30. Thus the ratchet wheel 20 rotates clockwise to fasten a fastening element. When the ratchet wrench 10 rotates counter-clockwise, the ratchet wheel 20 is restricted by the fastening element and the left resisting element 50 is pushed away by the directional block 60. Thus, the ratchet wrench 10 cannot drive the stopping teeth 30 to rotate the ratchet wheel 20. That is, there is a disengagement of the ratchet wheel 20 with the stopping teeth 30, as shown in FIG. 5. Therefore, when the directional block 60 causes the left resisting element 50 to move away, the ratchet wrench 10 can only rotate clockwise.

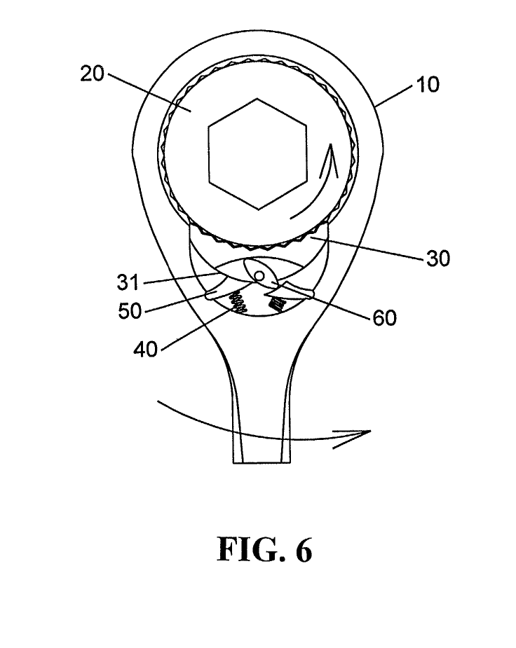

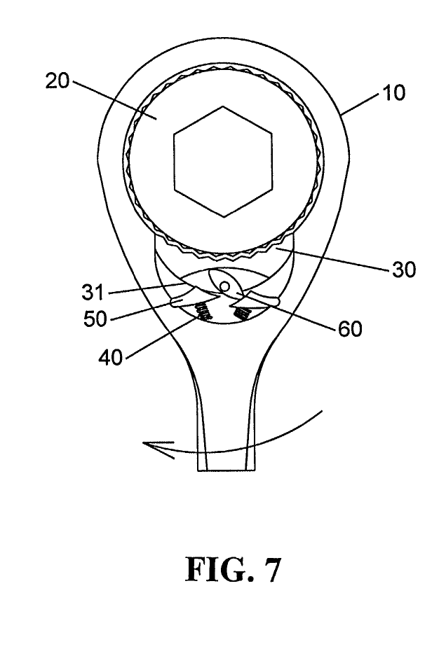

Referring to FIG. 6, if the directional block 60 is rotated in another direction, the directional block 60 urges the right resisting element 50 such that the right resisting element 50 is disengaged from the stopping teeth 30. When the ratchet wrench 10 rotates counter-clockwise, the ratchet wrench 10 presses against the left resisting element 50, and the left resisting element 50 again presses the stopping teeth 30. Thus, the ratchet wrench can counterclockwise rotate the ratchet wheel 20 to rotate the fastening element. When the ratchet wrench rotates clockwise, the ratchet wheel 20 is restricted by the fastening element and the right and left resisting elements 50 and the right and left resisting element 50 are pushed away by the directional block 60. Thus, the ratchet wrench 10 cannot drive the stopping teeth 30 to rotate the ratchet wheel 20. Thus the ratchet wrench 20 and the stopping teeth 30 are not in engagement, which is shown in FIG. 7. When the directional block 60 causes the right resisting element 50 being pushed away, the ratchet wrench 10 can only rotate counter-clockwise to fasten a fastening element.

As shown in FIG. 3, when the directional block 60 is at the original position, the left and fight resisting element 60 can urge the stopping teeth 30. Thus, counter-clockwise and clockwise rotating can fasten a fastening element.

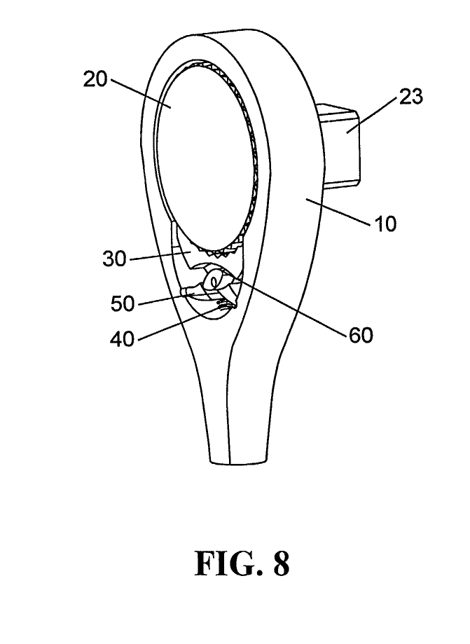

Referring to FIG. 8, the present structure can also use with sockets of a wrench. A hexagonal recess 21 is formed on a ratchet wrench 10 and is protruded out with a mounting end 23. The mounting end 23 can mount with sockets to provide the function as that provided by a wrench with sockets.

In view of the above, the advantages of the present invention are as follows:

1) If the stopping teeth is not in engagement with the ratchet wheel, the stopping teeth moves downward and the elastic body causes the stopping teeth to move upward, thus, the stopping teeth can engage with the ratchet wheel.

2) The width of the stopping teeth approximately equals to that of the adaptation recess, by the method of left and right rotating method, the width of the stopping teeth must smaller than that of the adaptation recess so that the stopping teeth can move to the left and right. However, the width of the stepping teeth can be larger than that of the disclosed art. As a result, the number of the mounting teeth of the stopping teeth with the ratchet wheel can be increased and thus, it can withstand a higher torque.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An improved structure of a ratchet wrench characterized in that the ratchet wrench is provided with an adaptation hole to accommodate a ratchet wheel having a plurality of mounting teeth surrounding the external circumferential edge, one lateral side of the adaptation hole is provided with an adaptation recess to accommodate a stopping teeth, a directional block, two resisting element and two elastic bodies, and two resisting edges are provided at an appropriate position on the adaptation recess, and a notch is formed on the stopping teeth which is protruded out with a pivotal rod, the directional block is pivotally mounted to the pivotal rod, and one side of the stopping teeth is provided with a plurality of engaging teeth which is engageable with the engaging teeth of the ratchet wheel, the side face of the stopping teeth is restricted by a left and a right resisting element, and the top end of the two resisting element is formed into a bottom end which is restricted at the stopping face of the stopping teeth, the end terminal of the resisting element is formed into a resisting edge and is then urged at the resisting edge of the adaptation recess, and the two resisting elements are urged by the elastic body such that the elasticity of the elastic body can be engaged with the ratchet wheel, thereby the rotating of the directional block will push to press the resisting element to urge the resisting element and the stopping teeth to separate and the ratchet wrench rotates in one direction, and the pushing of another resisting element will separate the resisting element from the stopping teeth, and the ratchet wrench will rotate in another direction.

2. An improved structure of a ratchet wrench as set forth in claim 1, wherein the internal diameter of the bottom end of the adaptation hole is formed into an engaging edge.

3. An improved structure of a ratchet wrench as set forth in claim 1, wherein the center of the ratchet wheel is formed into a hexagonal recess or other shapes of recesses in association with a fastening element.

4. An improved structure of a ratchet wrench as set forth in claim 1, wherein the ratchet wrench is protruded with a mounting and to accommodate with a mounting socket.
